(19) United States
(12) Patent Application Publication
(10) Pub. No.: US 2014/0339308 A1
(43) Pub. Date: Nov. 20, 2014

(54) RFID TAG AND AUTOMATIC RECOGNITION SYSTEM

(71) Applicants: Toshihiro Endou, Oyama-shi (JP); Hironori Ishizaka, Yuuki-shi (JP); Masahiko Oota, Oyama-shi (JP); Kouji Tasaki, Chikusei-shi (JP); Hiroyuki Hosoi, Higashikurume-shi (JP)

(72) Inventors: Toshihiro Endou, Oyama-shi (JP); Hironori Ishizaka, Yuuki-shi (JP); Masahiko Oota, Oyama-shi (JP); Kouji Tasaki, Chikusei-shi (JP); Hiroyuki Hosoi, Higashikurume-shi (JP)

(21) Appl. No.: 14/344,109

(22) PCT Filed: Sep. 7, 2012
(86) PCT No.: PCT/JP2012/072972

§ 371 Date: Mar. 11, 2014

(30) Foreign Application Priority Data
Sep. 12, 2011 (JP) 2011-198228

(51) Int. Cl. G06K 19/077

(52) U.S. Cl. CPC G06K 19/07779; G06K 19/07775; G06K 19/07745
USPC 235/439; 235/492

(57) ABSTRACT

An RFID tag having a resin substrate, an IC chip positioned in the center section on the substrate, a single-layer antenna for forming an electric closed circuit by connecting with the IC chip and positioned in the peripheral section of the IC chip, and a sealing material for sealing the IC chip and the antenna, wherein the antenna is a coil antenna or a loop antenna, the resonant frequency (f₀) of the antenna is the operating frequency of the IC chip or thereabouts, the operating frequency of the IC chip is 13.56 MHz-2.45 GHz, or 0.86-0.96 GHz, and the size of the RFID tag is 13 mm or less in length, 13 mm or less in width, and 1.0 mm or less in height; and an automatic recognition system using the same.

### TECHNICAL FIELD

The present invention relates to a radio frequency identification (RFID) tag transmitting and receiving information in non-contact manner in cooperation with a general-purpose reader/writer.

### BACKGROUND ART

For the purpose of indentifying and managing product information and preventing counterfeiting, many non-contact RFID tags (hereinafter, just referred to as just RFID tags) including IC chips are used in commercial goods, packages, cards, documents, and the like. IC chips include information such as names and prices of commercial goods, and the information of the IC chips can be read wirelessly by a reader or a reader/writer (hereinafter, the reader and reader/writer are also correctively referred to as a reader and the like) to be used for management, sale, and use of commercial goods. In some of the IC chips, information such as manufacturing date and factory or balance can be written by a reader/writer at a later date. In such a manner, the RFID tags have great benefits in increasing the convenience of merchandise management, increasing security, and preventing human errors.

RFID tags are usually attached to products or are incorporated in cards. Accordingly, the RFID tags are strongly required to be compact and thin. In recent years, RFID tags have attracted attentions for use in products and the like which are conventionally managed with engraved or written lot numbers or are not managed in particular. Specifically, RFID tags have attracted attentions for use in management of glasses, watches, medical samples, semiconductors, and the like (hereinafter, small articles having complicated shapes like glasses or having a size of several cm long by several cm wide by several cm height. (the several cm means 2 to 3 cm. The same applies hereinafter) is referred to as high-variety small products). The RFID tags are helpful for management of factories, workers, manufacture dates, used materials, dimensions, properties, and stocks of commercial goods (samples) and can reduce the trouble of management workers to prevent mistakes. For implementing such a convenient management system, RFID tags need to be compact and thin.

As one of comparatively compact and thin RFID tags, as illustrated in FIG. 1, RFID tags 80 are disclosed which include an antenna 20 formed on a film substrate 1 and an IC chip 30 mounted on the same (Patent Literatures 1 and 2). Moreover, as one of more compact RFID tags, an RFID tag is disclosed which is obtained by attaching an antenna pattern and an IC chip onto a substrate and then sealing the same into a package (Patent Literature 3). Moreover, another disclosed one is obtained by attaching an IC chip on an independent antenna pattern and then sealing the same into a package (Patent Literature 4). The RFID tag does not include a substrate so as to be thinner and flatter. Furthermore, as illustrated in FIG. 2, as RFID tags miniaturized to IC chip size, RFID tags are disclosed in which an antenna 20 is formed directly on the IC chip 30 (an on-chip antenna) (Patent Literatures 5 and 6).

### CITATION LIST

### Patent Literature

Patent Literature 1: Japanese Patent Laid-open Publication No. 2006-221211
Patent Literature 2: Japanese Patent Laid-open Publication No. 2011-103060
Patent Literature 3: Japanese Patent Laid-open Publication No. 2010-152449
Patent Literature 4: Japanese Patent Laid-open Publication No. 2001-052137
Patent Literature 5: Japanese Translation of PCT International Application Publication 2005/024949
Patent Literature 6: Japanese Patent Laid-open Publication No. 2007-189499

### SUMMARY OF INVENTION

### Problem to be Solved by Invention

The RFID tags of Patent Literatures 1 and 2 are comparatively compact and thin and are capable of communicating with a general-purpose reader or the like at distances of not less than 200 mm. However, the antenna provided on the film base material needs to have a size of about several cm long or wide. Accordingly, such RFID tags are not applicable when objects to which the RFID tags are attached are the aforementioned high-variety small articles. The products on which the RFID tags can be attached and the attachment thereof are greatly restricted.

The RFID tags of Patent Literatures 3 and 4 are as compact as several mm square (several mm long by several mm wide. The several mm means 2 to 3 mm. The same applies hereinafter) and are applicable to high-variety small products. However, in the RFID tag of Patent Literature 3, the antenna is provided for plural layers, and the base material on which the antenna is provided needs to have a multilayer structure. This can increase the cost and also increase the entire thickness. The RFID tag of Patent Literature 4 is manufactured by using a lead frame-like member including plural antennas which are connected and are not supported on a substrate. Accordingly, when the lead frame-like member is cut into individual packages after being sealed, the cutting surface of each antenna is exposed to the outside of the package, raising concerns about the influence of environmental deterioration and the like on the communication characteristics and reliability. Moreover, RFID tags having a size of several mm square like Patent Literatures 3 and 4 generally have a communication distance of 1 to 2 mm or shorter, which is not practically enough. The communication distance can be increased by some measures of the reader's side. However, this will require a dedicated reader and the like, and general-purpose readers and the like will not be used, thus causing a problem of inconvenience.

The RFID tags of Patent Literatures 5 and 6 have the same size as IC chips (about several hundreds μm square) and are applicable enough to high-variety small products. However, the communication distance was as short as not longer than 1 mm or the level of contact, and these RFID tags have problems of low working efficiency and flexibility at sites where the RFID tags are actually used. On the other hand, to increase the communication distance, it is necessary to increase the size of the IC chips themselves, thus increasing the cost.

If RFID tags have a size of dozen mm square or less and have a communication distance of several mm (2 to 3 mm) or longer, the RFID tags can be applied to a wider range of goods including high-variety small products. Moreover, such RFID tags can be read by general-purpose readers and the like and have very high utility value in industry. However, as described above, the RFID tags having a size in the order of several mm square or less has a short communication distance and are inconvenient in practical use. In the case where the products to which the RFID tags are applied are electronic components such as semiconductor packages, injection-molded products, and the like, the RFID tags need to be resistant to heat of 250 to 300° C. for several seconds because the electronic components and the like are heated at reflow and molding processes or are exposed to heat generated at use. However, such heat resistance is not considered.

The present invention was made in the light of the aforementioned problems, and an object of the present invention is to provide an RFID tag which is compact (1.7 to 13 mm square) ensures the communication distance, has resistances to heat and environment, and can be manufactured at lower cost than the conventional on-chip antennas and packaged RFID tags and to provide an automatic recognition system including the RFID tag.

### Means for Solving Problems

The present invention relates to the followings:

1. An RFID tag including: a substrate made of resin; an IC chip which is provided on the center of the substrate; a single-layer antenna which is provided in part around the IC chip and is connected to the IC chip to constitute an electrically closed circuit; and a sealing material sealing the IC chip and antenna, in which the antenna is any one of coil and loop antennas, and the resonant frequency f₀ of an electric circuit including an inductance L of the antenna and a capacitance C of the IC chip is equal to or close to the operation frequency of the IC chip, the operation frequency of the IC chip is in a range from 13.56 MHz to 2.45 GHz or in a range from 0.86 to 0.96 GHz, and the RFID tag has a size of not larger than 13 mm long by not larger than 13 mm wide by not larger than 1.0 mm high, a size of not larger than 4 mm long by not larger than 4 mm wide by not larger than 0.4 mm high, a size of not larger than 2.5 mm long by not larger than 2.5 mm wide by not larger than 0.3 mm high, or a size of not larger than 1.7 mm long by not larger than 1.7 mm wide by not larger than 0.3 mm high.

2. The RFID tag in the above paragraph 1, in which the operation frequency of the IC chip is in the range from 0.86 to 0.96 GHz while the resonant frequency f₀ of the electric circuit including the inductance L of the antenna and the capacitance C of the IC chip is 0.2 to 2 GHz, or the operation frequency of the IC chip is 13.56 MHz while the resonant frequency f₀ is 13.56 to 29 MHz, or the operation frequency of the IC chip is 2.45 GHz while the resonant frequency f₀ is 2 to 2.45 GHz.

3. The RFID tag in the above paragraph 1 or 2, in which constituent portions of the antenna adjacent to each other with a gap therebetween provide a capacitance, and the substantial capacitance of the entire structure including the IC chip and the antenna provided in the part around the IC chip is higher than the capacitance of the IC chip alone.

4. The RFID tag in any one of the above paragraphs 1 to 3, in which the IC chip is directly connected to ends of the antenna by wire bonding or flip-chip connection.

5. The RFID tag in any one of the above paragraphs 1 to 4, in which the conductor width/conductor interval of the antenna is in a range from 0.2/0.2 mm to 0.05/0.05 mm.

6. The RFID tag in any one of the above paragraphs 1 to 5, in which the sealing material has a dielectric constant of not less than 2.6.

7. The RFID tag in any one of the above paragraphs 1 to 6, in which the sealing material has a dielectric constant of not less than 3.5.

8. The RFID tag in any one of the above paragraphs 1 to 7, in which the substrate includes polyimide or glass epoxy, and the sealing material is mainly composed of epoxy, carbon, and silica.

9. The RFID tag in any one of the above paragraphs 1 to 8, in which the antenna is formed on only one side of the substrate, and the antenna, the IC chip, and a wire for wire bonding are sealed together using the sealing material to be not exposed in the surface of the sealing material.

10. An automatic recognition system including: an RFID tag according to the above paragraphs 1 to 9; and any one of a reader and a reader/writer.

### Effect of Invention

The present invention was made in the light of the aforementioned problems, and the present invention provides an RFID tag which is compact (1.7 to 13 mm square), ensures the communication distance, has resistances to heat and environment, and can be manufactured at lower cost than the conventional on-chip antennas and packaged RFID tags and to provide an automatic recognition system including the RFID tag.

### BRIEF DESCRIPTION OF DRAWINGS

FIG. 1 is a schematic view of a conventional RFID tag.

FIG. 2 is a schematic view of a conventional RFID tag.

FIG. 3 is a view illustrating the shape of antennas of an RFID tag of an embodiment.

FIG. 4 is a schematic view of the RFID tag of the embodiment.

FIG. 5 is a diagram showing an electrically equivalent circuit to a coil antenna connected to an IC chip.

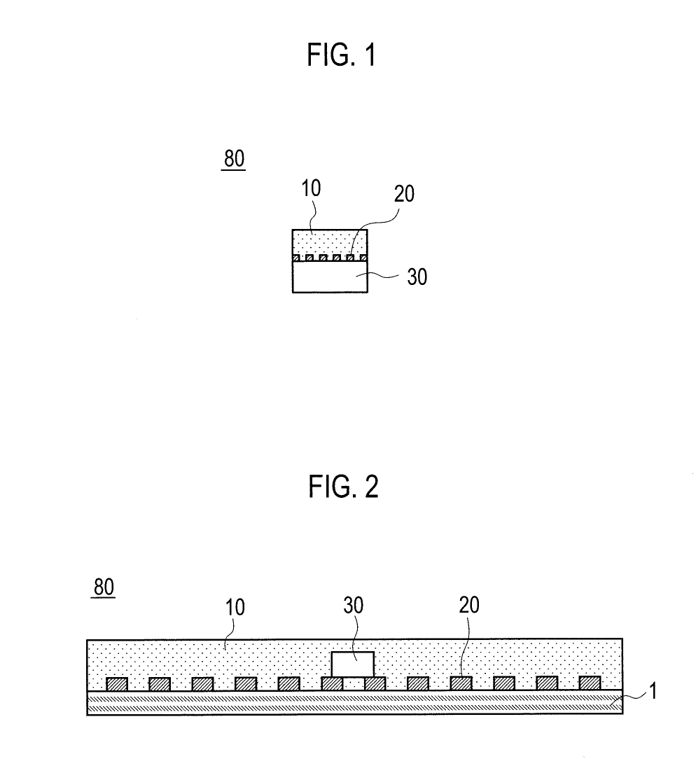

### MODES FOR CARRYING OUT INVENTION

The substrate of the present invention is to support an antenna and an IC chip. The substrate is made of resin. A suitable material as the substrate made of resin is resistant to heat of 250 to 300° C. for several seconds, has a mechanical strength, and has a small thermal expansion coefficient. Such suitable heat resistance is necessary when the RFID tag is exposed to heating in the reflow and molding process or exposed to heat generation at use. The material of the substrate can be glass epoxy, phenol, polyimide, or the like. In order to uniformly form antennas at low cost, it is effective to use a base material with metallic foil that includes metallic foil attached onto one surface of the base material and to form an antenna by etching. Furthermore, in order to obtain thinner RFID tags, it is effective that the base material is as thin as 10 to 50 μm. One of the base materials satisfying the aforementioned conditions is a polyimide base material with copper foil, that includes copper foil on one surface of a polyimide base material (for example, MCF-50001 made by Hitachi Chemical Co., Ltd.; polyimide thickness, 25 μm; copper foil thickness, 18 μm). Paper phenol, glass epoxy. and polyimide have dielectric constants of 4.6 to 7.0, 4.4 to 5.2, and 3.5, respectively, and can be all utilized. If the dielectric constant of the base material increases, the inductance increases, and the antenna can be reduced in size. As a result, it is desirable that the substrate is made of a polyimide base material with copper foil, which has a lower dielectric constant than paper phenol and glass epoxy, because the polyimide base material with copper foil can be made thin, has heat resistance and high mechanical strength, and provides good formation of antennas.

The antenna of the present invention is electromagnetically coupled with a reader or the like to receive electric power and transmits the electric power to an IC chip to operate the IC chip. The antenna is composed of a single layer and does not need to be composed of plural layers. Accordingly, it is desirable that the antenna is made of copper foil of the polyimide base material with copper foil, which includes copper foil as a metallic layer attached on one surface of the substrate, because the antenna can be uniformly formed at low cost.

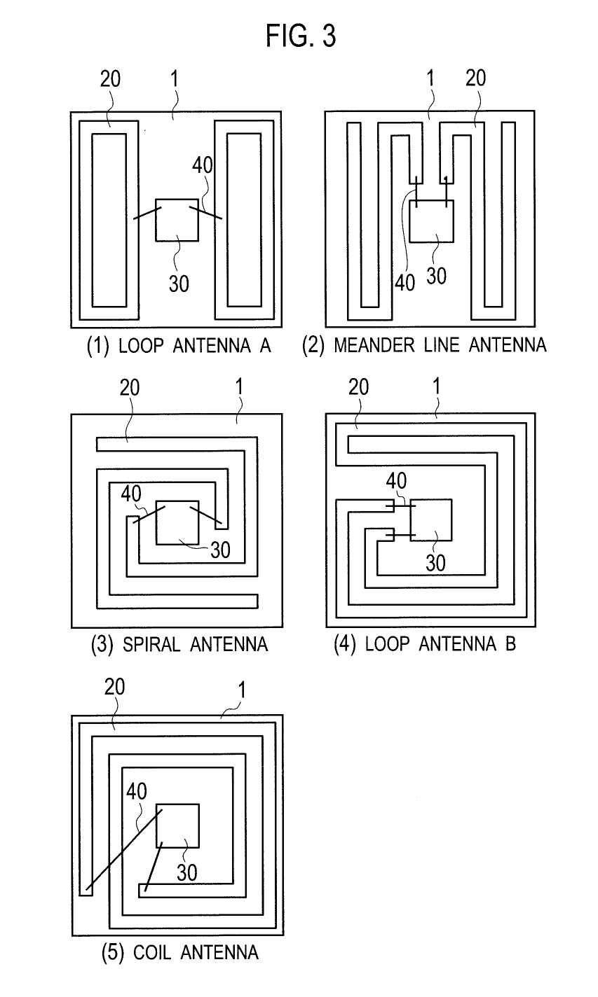

As illustrated in FIG. 3, an IC chip 30 is provided on the center of a substrate 1 made of resin, and an antenna 20 is provided in the part around the IC chip 30 on one surface of the substrate 1. The antenna 20 is arranged in a region large enough for the antenna 20 to extend in the outer periphery of the substrate 1. This increases the flexibility of the shape of the antenna and facilitates adjustment of the resonant frequency of an electric circuit composed of inductance L of the antenna 20 and capacitance C of the IC chip (hereinafter, also referred to as a LC resonant circuit. Herein, L and C indicate the inductance and capacitance, respectively). In the case of a coil antenna, since the antenna 20 is arranged in the part around the IC chip 30, the coil has a larger diameter and therefore has a larger inductance. The coil antenna is advantageous for ensuring the communication distance and miniaturization. The antenna 20 is connected to the IC chip 30 to form an electrically closed circuit and does not have an open end. Concrete examples of the antenna which is connected to the IC chip 30 to form an electrically closed circuit and does not have an open end include a loop antenna B of (4) of FIG. 3 and a coil antenna of (5) of FIG. 3. Accordingly, even if the RFID tag is small, the antenna 20 can be easily designed as an LC circuit and can efficiently produce an inductance with a small area, which is advantageous to ensure the communication distance.

The representative examples of the antenna shape are shown in (1) to (5) of FIG. 3. The shape of the antenna 20 is designed so that the resonant frequency of an electric circuit (LC resonant circuit) composed of the inductance of the antenna 20 and the capacitance of the IC chip 30 is equal to or close to the operation frequency of the IC chip 30. The shape of the antenna 20 can be the shape of meander line antennas ((2) of FIG. 3), loop antennas ((1), (4) of FIG. 3), coil antennas ((5) of FIG. 3), spiral antennas ((3) of FIG. 3), and the like which are widely used as an antenna. Among these antennas, the coil antenna ((5) of FIG. 3) and loop antenna B ((4) of FIG. 3), each of which is connected to the IC chip 30 to form an electrically closed circuit, are desirable. This is because the electric circuit can be easily designed as a resonant circuit and can efficiently produce an inductance with small area, thus miniaturizing the RFID tag. Especially the coil antenna ((5) of FIG. 3) is desirable. The design method of the antenna 20 is described later. When the antenna 20 is a coil antenna, the antenna 20 can be provided by mounting a winding coil with an adhesive or the like. However, more stable performances including the inductance can be obtained with a coil manufactured by etching than the winding coil. Moreover, fine wires with a conductor width/conductor interval of 0.2/0.2 mm to 0.05 /0.05 mm can be formed by etching, and etching is advantageous for miniaturization. Furthermore, the etching process is excellent in mass production and is therefore industrially effective. Moreover, when the antenna 20 is designed to have the aforementioned shape, the antenna 20 includes constituent portions adjacent to each other with a gap therebetween, and with contribution of the dielectric constants of the base material 1 and sealing material 10, the adjacent constituent portions are capacitively coupled to provide a capacitance therebetween. Accordingly, the effective capacitance, which is a substantial capacitance of the entire structure including the IC chip 30 and the antenna placed in the part around the IC chip 30, is considerably higher than the capacitance of the IC chip 30 alone. Herein, the substantial capacitance refers to a capacitance provided by the IC chip 30 in the structure in which the antenna is provided in the part around the IC chip 30.

FIG. 3 also illustrates the IC chip 30 and wire 40 wire-bonded. In the process of forming the antenna 20 by etching copper foil of the polyimide base material with copper foil, the copper foil in a part where the IC chip 30 is mounted is left to form a die pad (not shown). This can keep the rigidity in a connection process such as wire bonding of the IC chip 30, thus increasing the yield.

On the copper foil in the part where the IC chip 30 is mounted, die-bond film (not shown) is provided, and the IC chip 30 is fixed thereon. The IC chip 30 can be a read-only IC chip but is preferably an IC chip in which information can be written. Such an IC chip is suitable because the operation history and the like can be written in the IC chip as needed. Thereafter, the IC chip 30 and antenna 20 are directly connected with wire bonding. In the coil antenna 20 of (5) of FIG. 3, the two antenna ends are located to sandwich the antenna 20. The antenna ends and the IC chip 30 are directly connected with the wires 40 for wire bonding across the antenna 20 located between the antenna ends. It is therefore unnecessary to provide a jumper or to provide plural layers and connect the antenna ends to IC chip 30 through a through-hole, thus reducing the cost.

Almost all kinds of antennas can be flip-chip connected to the IC chip if the interconnection places are regulated. All the antennas are flip-chip connected by multilayer interconnection using a double-sided copper foil base material or the like. However, use of the double-sided copper foil base material reduces the mass production and increases the cost, and the wires are exposed in the surface after the sealing process. Accordingly, it is preferable to use a single-sided copper foil base material.

By multilayer interconnection using copper foil double-sided base material or the like, the coil diameter of the coil antenna in particular can be reduced, and the length and width of the RFID tag can be reduced, thus realizing miniaturization. However, in this case, the height thereof is increased a little. The disadvantages thereof include reduction in mass production, an increase in cost, and exposure of wires in the surface after the sealing process. Accordingly, it is desirable that the antenna 20 is a single-layer coil antenna formed using a single-sided copper foil base material.

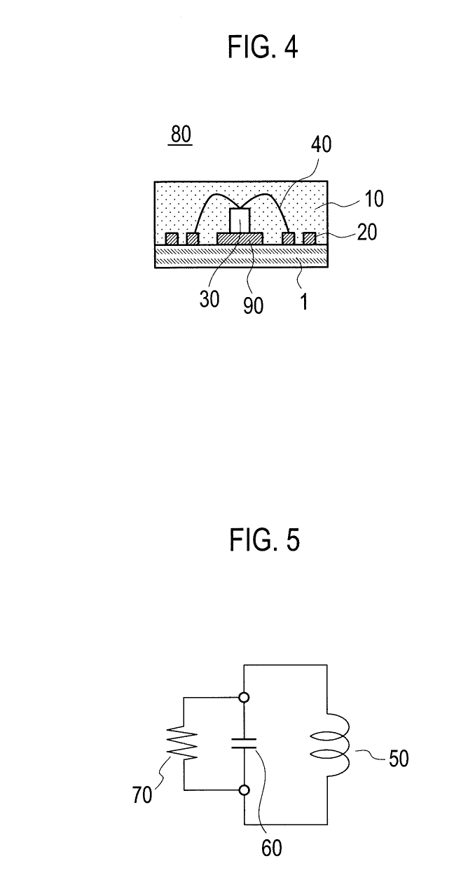

FIG. 4 is a cross-sectional view illustrating the RFID 80 after sealing. The IC chip 30, antenna 20, and wires 40, which are mounted on the die pad 90 on the substrate 1, are sealed together using a sealing material 10 to be protected. The substrate 1 is thin, and the antenna 20 of a single layer is provided on only one side of the substrate. Accordingly, the thickness of the sealed RFID tag 80 is about 0.2 to 1.0 mm. The metal wire portions of the IC chip 30, antenna 20, wire 40, and the like are all sealed are sealed to form a structure which cannot be externally touched after the sealing process. This increases safety and reliability of the RFID tag in terms of environmental deterioration and also counterfeit prevention.

The sealing material can be a sealing material usually used in semiconductors and has a dielectric constant of about 2.6 to 4.5. In order to increase the performance of the RFID tag itself, it is more preferable that the sealing material has a lower dielectric constant. However, as the dielectric constant increases, the inductance increases, and the antenna can be miniaturized.

In the RFID tag thus produced, the substrate is resistant to heat of 180° C. or higher, and the sealing material is resistant to heat of 150° C. or higher. Moreover, wire bonding is used. Accordingly, the RFID tag thus produced is more resistant to heat than conventional RFID tags including antennas formed on PET or the like and can operate normally even at high temperature. When the RFID tags are attached to products such as electronic components including semiconductor packages, injection-molded products, and the like, the RFID tags need to be resistant to heat of 250 to 300° C. for several seconds because the electronic components and the like are exposed to heating at reflow and molding processes or to heat generation at use.

Hereinafter, the antenna design method is described. The antenna design is based on the resonant frequency which is determined by the shape, line thickness, and line length of the antenna conductor and the like. When the resonant frequency is brought close to the operation frequency of the employed IC chip, the antenna receives power from a reader/writer and transmits the same to the IC chip, and the IC chip then operates.

Generally, it is difficult to analytically derive the resonant frequency from the drawings of an antenna. Actually, the resonant frequency is obtained by experimental measurement using an antenna experimentally produced in many cases. The invented RFID tag is compact, and it is impossible to experimentally produce an antenna accurately by handwork. On the other hand, it takes a lot of time and cost to manufacture an antenna by performing the process of forming an etching mask to the process of etching. Accordingly, in the present invention, the antenna design is performed by using an electromagnetic simulator (simulator software HFSS made by ANSYS Japan K. K.) to reduce the time and cost. By inputting the shape and material of an antenna, the capacitance of an IC chip, and the like to the electromagnetic simulator, the resonant frequency is obtained from the result of simulation. The antenna is designed so that the resonant frequency f₀ of the electric circuit which is composed of an inductance L of the antenna and a capacitance C of the IC chip and is calculated by the electromagnetic simulator is equal to or close to the operation frequency of the IC chip and thereabout. The resonant frequency in this case refers to a frequency at which the imaginary part of the impedance of the electrically closed circuit obtained when the IC chip is connected to the both ends of the antenna is equal to zero.

The way of easily understanding the design principal is to give consideration to an electrically closed circuit obtained when the IC chip is connected to both ends of a coil antenna, which can be considered equivalent to a simple LC resonant circuit. FIG. 5 shows an electrically equivalent circuit to the coil antenna of (5) of FIG. 3. The resonant frequency f₀ in this case is expressed by the following equation using the inductance L of a coil 50, which is an equivalent circuit to the coil antenna, and the capacitance C of a capacitor 60, which is an equivalent circuit to the IC chip 30.

$${( 2 π {f}_{0} )}^{2} = \frac{1}{LC} \qquad [ Equation ]$$

Herein, C can change depending on the choice of the IC chip 30, and L can be adjusted by changing the shape of the coil antenna (especially the diameter and the number of turns of the coil antenna). The intended resonant frequency f₀ can be thus generated. The adjustment of L is especially effective. If the inductance L is increased by increasing the diameter or the number of turns of the coil antenna, f₀ is reduced.

In the above equation, the capacitance C of the IC chip 30 is the effective capacitance of the structure where the antenna 20 (coil 50) is arranged in the part around the IC chip 30. In this embodiment, capacitance components are generated between the constituent portions of the antenna 20 adjacent with a gap therebetween, and furthermore, with contribution of the dielectric constants of the substrate I and sealing material 10, a capacitance is generated therebetween. Accordingly, the effective capacitance which is a substantial capacitance of the entire structure including the IC chip 30 and the antenna arranged in the part around the IC chip 30 is considerably higher than the capacitance of the IC chip 30 alone. As apparent from the above equation, the desired resonant frequency f₀ can be generated with a smaller inductance L. Accordingly, the coil 50 can be reduced in size by reducing the diameter or the number of turns, thus miniaturizing the entire RFID tag 80.

The resonant frequency (operation frequency) of the RFID tag (IC chip 30) is preferably in a range from 13.56 MHz to 2.45 GHz, which is especially commercially useful in the Radio Act. In the case of RFID tags having an operation frequency of 0.86 to 0.96 GHz in the ultra high frequency band (UHF), the wavelength of the radio waves is about 30 cm. On the other hand, normal IC chips for the UHF band have a size of 0.6 mm square or smaller. It is therefore impossible to form on the IC chip, an antenna allowing the IC chip to normally operate. Moreover, even in RFID tags having a size of several mm square, an antenna formed by the conventional design method yields a communication distance of only several mm. However, the RFID tag of the present invention by the design method using the electromagnetic simulator has an excellent characteristic that the communication distance at which the RFID tag can operate can be considerably increased using a single-layer antenna having a size of only several mm square instead of a conventional several cm square antenna. Moreover, the antenna employed in the present invention can be an antenna having a size of several mm square and a conductor width/conductor interval of several tens to several hundreds micrometers and can be therefore easily formed by etching a metal layer such as copper foil or by another method. Furthermore, the antenna of the present invention can be a single-layer antenna and does not need to have a multilayer structure. Accordingly, the antenna of the present invention can be composed of copper foil of a polyimide base material with copper foil, in which copper foil as a metal layer is attached to one side of the base material. Accordingly, the RFID tag can be formed by a general-purpose process using a general-purpose low-cost material.

The RFID tag 80 of the present invention can be embedded in a semiconductor device or the like for use. Moreover, the RFID tag 80 can be attached to a product or a sample with double-sided tape like a label for use in management or the like and can be easily detached at the time of selling the product. Furthermore, the RFID tag of the present invention is combined with a reader to constitute an automatic recognition system with long communication distance and good workability even for high-variety small products such as glasses, watches, medical samples, and semiconductors. In this case, the RFID tag of the present invention, which has a long communication distance, can be combined with a general-purpose reader or the like to constitute an automatic recognition system.

### EXAMPLES

### Example 1

As the resin base material, a polyimide base material with copper foil, in which copper foil was attached to one side of the polyimide base material, was prepared (MCF-50001 made by Hitachi Chemical Co., Ltd.; polyimide thickness, 25 μm; copper foil thickness, 18 μm). The copper foil of the polyimide base material with copper foil was etched to form coil antennas as illustrated in (5) of FIG. 3 with conductor width/conductor intervals of 0.05/0.05 mm, 0.1/0.1 mm, and 0.2/0.2 mm each in a 4 mm square range. Moreover, die pads (not shown) on which the respective IC chips were mounted were formed.

Next, each employed IC chip had a size of about 0.5×0.5×0.1 mm, a capacitance of 0.77 pF, and an operation frequency of about 0.86 to 0.96 GHz. The IC chip was mounted on the die pad using a die bonding material and directly connected to the antenna by wire bonding. Next, the antenna, IC chip, and wires for wire bonding on one side of the substrate were sealed with the sealing material. Eventually, the resultant product was diced into required size to produce RFID tags.

### Example 2

The copper foil of the polyimide base material with copper foil was etched to form loop antennas B as illustrated in (4) of FIG. 3 with conductor width/conductor intervals of 0.05/0.05 mm, 0.1/0.1 mm, and 0.2/0.2 mm each in a 4 mm square range. The other process was performed in the same manner as that of Example 1 to produce RFID tags.

### Comparative Example 1

The copper foil of the polyimide base material with copper foil was etched to form meander line antennas as illustrated in (2) of FIG. 3 with conductor width/conductor intervals of 0.05/0.05 mm, 0.1/0.1 mm, and 0.2/0.2 mm each in a 4 mm square range. The other process was performed in the same manner as that of Example 1 to produce RFID tags.

### Comparative Example 2

The copper foil of the polyimide base material with copper foil was etched to form loop antennas A as illustrated in (1) of FIG. 3 with conductor width/conductor intervals of 0.05/0.05 mm, 0.1/0.1 mm, and 0.2/0.2 mm each in a 4 mm square range. The other process was performed in the same manner as that of Example 1 to produce RFID tags.

### Comparative Example 3

The copper foil of the polyimide base material with copper foil was etched to form spiral antennas as illustrated in (3) of FIG. 3 with conductor width/conductor intervals of 0.05/0.05 mm, 0.1/0.1 mm, and 0.2/0.2 mm each in a 4 mm square range. The other process was performed in the same manner as that of Example 1 to produce RFID tags.

### Example 3

The copper foil of the polyimide base material with copper foil was etched to form a coil antenna as illustrated in (5) of FIG. 3 with a conductor width/conductor interval of 0.1/0.1 mm in a 2.5 mm square range. The other process was performed in the same manner as that of Example 1 to produce an RFID tag.

### Example 4

The copper foil of the polyimide base material with copper foil was etched to form loop antennas B as illustrated in (4) of FIG. 3 with conductor width/conductor intervals of 0.05/0.05 mm, 0.1/0.1 mm, and 0.2/0.2 mm each in a 2.5 mm square range. The other process was performed in the same manner as that of Example 1 to produce RFID tags.

### Comparative Example 4

The copper foil of the polyimide base material with copper foil was etched to form meander line antennas as illustrated in (2) of FIG. 3 with conductor width/conductor intervals of 0.05/0.05 mm, 0.1/0.1 mm, and 0.2/0.2 mm each in a 2.5 mm square range. The other process was performed in the same manner as that of Example 1 to produce RFID tags.

### Comparative Example 5

The copper foil of the polyimide base material with copper foil was etched to form loop antennas A as illustrated in (1) of FIG. 3 with conductor width/conductor intervals of 0.05/0.05 mm, 0.1/0.1 mm, and 0.2/0.2 mm each in a 2.5 mm square range. The other process was performed in the same manner as that of Example 1 to produce RFID tags.

### Comparative Example 6

The copper foil of the polyimide base material with copper foil was etched to form spiral antennas as illustrated in (3) of FIG. 3 with conductor width/conductor intervals of 0.05/0.05 mm, 0.1/0.1 mm, and 0.2/0.2 mm each in a 2.5 mm square range. The other process was performed in the same manner as that of Example 1 to produce RFID tags.

### Example 5

The copper foil of the polyimide base material with copper foil was etched to form a coil antenna as illustrated in (5) of FIG. 3 with a conductor width/conductor interval of 0.1/0.1 mm in a 1.7 mm square range. The other process was performed in the same manner as that of Example 1 to produce an RFID tag.

### Example 6

The copper foil of the polyimide base material with copper foil was etched to form a coil antenna as illustrated in (5) of FIG. 3 with a conductor width/conductor interval of 0.1/0.1 mm in a 9 mm square range. The IC chip had a size of about 0.5×0.5×0.1 mm, a capacitance of 17 pF, and an operation frequency of about 13.56 GHz. The other process was performed in the same manner as that of Example 1 to produce an RFID tag.

### Example 7

The copper foil of the polyimide base material with copper foil was etched to form a coil antenna as illustrated in (5) of FIG. 3 with a conductor width/conductor interval of 0.1/0.1 mm in a 13 mm square range. The other process was performed in the same manner as that of Example 6 to produce RFID tags.

### Example 8

The copper foil of the polyimide base material with copper foil was etched to form a coil antenna as illustrated in (5) of FIG. 3 with a conductor width/conductor interval of 0.2/0.2 mm in a 2.5 mm square range. The IC chip had a size of about 0.5×0.5×0.1 mm, a capacitance of 0.7 pF, and an operation frequency of about 2.45 GHz. The other process was performed in the same manner as that of Example 1 to produce an RFID tag.

### Example 9

The copper foil of the polyimide base material with copper foil was etched to form a coil antenna as illustrated in (5) of FIG. 3 with a conductor width/conductor interval of 0.1/0.1 mm in a 2.5 mm square range. The other process was performed in the same manner as that of Example 8 to produce an RFID tag.

Hereinafter, the method of reading evaluation and experiment results are described. The used reader writer was UI-9061 (output: 1 W) made by LSIS Co., Ltd. The reading evaluation of the RFID tag 80 was performed with no obstacles in a 25 cm square area around the reading unit of the reader/writer. Measurement was performed in terms of the maximum distance between the reading unit of the reader/writer and the RFID tag 80 when the reader/writer could read the RFID tag 80.

Table 1 shows the results of simulation and reading evaluation about Examples 1 to 5 and Comparative Examples 1 to 6. The IC chips used in the simulation and reading evaluation had a size of about 0.5×0.5×0.1 mm, a capacitance of 0.77 pF, and an operation frequency of about 0.86 to 0.96 GHz. Based on Table 1, the resonant frequencies of the coil antennas and loop antennas B, each of which was connected to an IC chip to form an electrically-closed circuit, were 0.2 to 2 GHz by the electromagnetic simulator and were substantially closer to 0.9 GHz, which was the operation frequency of the IC chip, than the other antennas were. The reading distances thereof provided better results than those of the meander line antennas, loop antennas A, and spiral antennas, each of which did not constitute an electrically closed circuit. Examples 1a, 1b, 2a, 2b, 3b, 4c, and 5c, the resonant frequencies of which were in a range from 0.5 to 1.5 GHz, had communication distances of not shorter than 5 mm. Examples 1a, 2b, and 3b in particular, the resonant frequencies of which were 1 to 1.1 GHz closer to 0.9 GHz (that is the operation frequency of the IC chip), had communication distances of longer than 20 mm.

TABLE 1

| | | | | CONDUCTOR | | SIMULATION | |
|---|---|---|---|---|---|---|---|
| | | | | WIDTH/ | NUMBER | RESONANT | READING |
| | | ANTENNA | RFID TAG | CONDUCTOR | OF | FREQUENCY | DISTANCE |
| EXAMPLES | | SHAPE | SIZE (mm) | INTERVAL (mm) | TURNS | (GHz) | (mm) |
| EXAMPLE 1 | a | Coil | 4 × 4 | 0.2/0.2 | 3 | 1 | 37 |
| | b | Coil | 4 × 4 | 0.1/0.1 | 7 | 0.5 | 8 |
| | c | Coil | 4 × 4 | 0.05/0.05 | 14 | 0.2 | 3 |
| EXAMPLE 2 | a | Loop B | 4 × 4 | 0.2/0.2 | — | 1.5 | 10 |
| | b | Loop B | 4 × 4 | 0.1/0.1 | — | 1.1 | 21 |
| | c | Loop B | 4 × 4 | 0.05/0.05 | — | 0.7 | 3 |
| COMPARATIVE | a | Meander | 4 × 4 | 0.2/0.2 | — | 8 | x |
| EXAMPLE 2 | | Line | | | | | |
| | b | Meander | 4 × 4 | 0.1/0.1 | — | 6 | x |
| | | Line | | | | | |
| | c | Meander | 4 × 4 | 0.05/0.05 | — | 6 | x |
| | | Line | | | | | |
| COMPARATIVE | a | Loop A | 4 × 4 | 0.2/0.2 | — | 11 | x |
| EXAMPLE 2 | b | Loop A | 4 × 4 | 0.1/0.1 | — | 11 | x |
| | c | Loop A | 4 × 4 | 0.05/0.05 | — | 8 | x |
| COMPARATIVE | a | Spiral | 4 × 4 | 0.2/0.2 | — | 4 | x |
| EXAMPLE 3 | b | Spiral | 4 × 4 | 0.1/0.1 | — | 2 | x |
| | c | Spiral | 4 × 4 | 0.05/0.05 | — | 1.5 | 1 |
| EXAMPLE 3 | b | Coil | 2.5 × 2.5 | 0.1/0.1 | 4 | 1.1 | 22 |
| EXAMPLE 4 | c | Loop B | 2.5 × 2.5 | 0.05/0.05 | — | 1.5 | 5 |
| COMPARATIVE | a | Meander | 2.5 × 2.5 | 0.2/0.2 | — | 14 | x |
| EXAMPLE 4 | | Line | | | | | |
| | b | Meander | 2.5 × 2.5 | 0.1/0.1 | — | 12 | x |
| | | Line | | | | | |
| | c | Meander | 2.5 × 2.5 | 0.05/0.05 | — | 11 | x |
| | | Line | | | | | |
| COMPARATIVE | a | Loop A | 2.5 × 2.5 | 0.2/0.2 | — | 15 | x |
| EXAMPLE 5 | b | Loop A | 2.5 × 2.5 | 0.1/0.1 | — | 15 | x |
| | c | Loop A | 2.5 × 2.5 | 0.05/0.05 | — | 13 | x |
| COMPARATIVE | a | Spiral | 2.5 × 2.5 | 0.2/0.2 | — | 8 | x |
| EXAMPLE 6 | b | Spiral | 2.5 × 2.5 | 0.1/0.1 | — | 5 | x |
| | c | Spiral | 2.5 × 2.5 | 0.05/0.05 | — | 4 | x |
| EXAMPLE 5 | c | Coil | 1.7 × 1.7 | 0.05/0.05 | 4 | 1.1 | 13 |

Herein, the marks × in the “READING DISTANCE” fields of Table 1 indicate that the reader/writer could not read the RFID tags even in contact with the same.

The antennas formed by etching can be more stably mass-produced at a high yield when the conductor width and the conductor interval are thick. Accordingly, in the case where the conductor width and conductor intervals are determined by process restrictions, it was considered how small the RFID tags could be while ensuring a reading distance of about 10 mm. The consideration revealed that the RFID tags could be miniaturized to a size of about 4.0 mm square when the conductor width/conductor interval was 0.2/0.2 mm. Moreover, it was revealed that the size of the RFID tags could be reduced to about 2.5 mm square when the conductor width/conductor interval was 0.1/0.1 mm. Moreover, it was revealed that that the size of the RFID tags could be reduced to about 1.7 mm square when the conductor width/conductor interval was 0.05/0.05 mm.

Table 2 shows the results of simulation and reading evaluation about Examples 6 and 7. The used IC chips had a size of about 0.5×0.5×0.1 mm, a capacitance of 17 pF, and an operation frequency of 13.56 MHz. Example 6, the resonant frequency of which was 29 MHz by the electromagnetic simulator, had a communication distance of 12 mm. Especially Example 7, the resonant frequency of which was 14 MHz by the electromagnetic simulator, had a communication distance of 110 mm. In the operation frequency of 13.56 MHz in the high frequency hand (HF band), which was lower than the UHF band, it was revealed that the size of the RFID tag could be reduced to about 13 mm square by increasing the inductance of the coil antenna when the conductor width/conductor interval was 0.1/0.1 mm.

TABLE 2

| | | | CONDUCTOR | | SIMULATION | |
|---|---|---|---|---|---|---|
| | | | WIDTH/ | NUMBER | RESONANT | READING |
| | ANTENNA | RFID TAG | CONDUCTOR | OF | FREQUENCY | DISTANCE |
| | SHAPE | SIZE (mm) | INTERVAL (mm) | TURNS | (MHz) | (mm) |
| EXAMPLE 6 | Coil | 9 × 9 | 0.1/0.1 | 20 | 29 | 12 |
| EXAMPLE 7 | Coil | 13 × 13 | 0.1/0.1 | 30 | 14 | 110 |

Table 3 shows the results of simulation and reading evaluation. The used IC chips had a size of about 0.5×0.5×0.1 mm, a capacitance of 0.7 pF, and an operation frequency of 2.45 GHz. Example 8, the resonant frequency of which was 2 GHz by the electromagnetic simulator, and Example 9, the resonant frequency of which was 2.1 GHz by the electromagnetic simulator, had communication distances of 4 mm. Moreover, it was revealed that the size of the RFID tags could be reduced to about 1.7 mm square when the conductor width/conductor interval was 0.1/0.1 mm.

TABLE 3

| | | RFID | CONDUCTOR | | SIMULATION | |
|---|---|---|---|---|---|---|
| | | TAG | WIDTH/ | NUMBER | RESONANT | READING |
| | ANTENNA | OUTER | CONDUCTOR | OF | FREQUENCY | DISTANCE |
| | SHAPE | SIZE (mm) | INTERVAL (mm) | TURNS | (GHz) | (mm) |
| EXAMPLE 8 | coil | 2.5 × 2.5 | 0.2/0.2 | 2 | 2 | 4 |
| EXAMPLE 9 | coil | 1.7 × 1.7 | 0.1/0.1 | 2 | 2.1 | 4 |

### INDUSTRIAL APPLICABILITY

The RFID tag of the present invention can be used for the purposes of management, identification, information presentation, information recording, and counterfeit prevention of products including commercial goods, packages, cards, documents, glasses, watches (especially small watches such as wristwatches), semiconductors, and medical uses (samples obtained from patients).

### EXPLANATION OF REFERENCE NUMERALS

1 Substrate
10 Sealing Material
20 Antenna
30 IC Chip
40 Wire Of Wire Bonding
50 Coil (Antenna)
60 Capacitance (IC Chip)
70 Port Inputted At Simulation
80 RFID Tag
90 Stainless Plate

1. An RFID tag comprising:
a substrate made of resin;
an IC chip which is provided on the center of the substrate;
a single-layer antenna which is provided in part around the IC chip and is connected to the IC chip to constitute an electrically closed circuit; and
a sealing material sealing the IC chip and antenna, wherein
the antenna is any one of coil and loop antennas, and
the resonant frequency f₀ of an electric circuit including an inductance L of the antenna and a capacitance C of the IC chip is equal to or close to the operation frequency of the IC chip,
the operation frequency of the IC chip is in a range from 13.56 MHz to 2.45 GHz and
the RFID tag has a size of not larger than 13 mm long by not larger than 13 mm wide by not larger than 1.0 mm high, a size of not larger than 4 mm long by not larger than 4 mm wide by not larger than 0.4 mm high, a size of not larger than 2.5 mm long by not larger than 2.5 mm wide by not larger than 0.3 mm high, or a size of not larger than 1.7 mm long by not larger than 1.7 mm wide by not larger than 0.3 mm high.

2. The RFID tag according to claim 1, wherein
the operation frequency of the IC chip is in the range from 0.86 to 0.96 GHz while the resonant frequency f₀ of the electric circuit including the inductance L of the antenna and the capacitance C of the IC chip is 0.2 to 2 GHz, or
the operation frequency of the IC chip is 13.56 MHz while the resonant frequency f₀ is 13.56 to 29 MHz, or
the operation frequency of the IC chip is 2.45 GHz while the resonant frequency f₀ is 2 to 2.45 GHz.

3. The RFID tag according to claim 1, wherein
constituent portions of the antenna adjacent to each other with a gap therebetween provide a capacitance, and the substantial capacitance of the entire structure including the IC chip and the antenna provided in the part around the IC chip is higher than the capacitance of the IC chip alone.

4. The RFID tag according to claim 1, wherein
the IC chip is directly connected to ends of the antenna by wire bonding or flip-chip connection.

5. The RFID tag according to claim 1, wherein
the conductor width/conductor interval of the antenna is in a range from 0.2/0.2 mm to 0.05/0.05 mm.

6. The RFID tag according to claim 1, wherein the sealing material has a dielectric constant of not less than 2.6.

7. The RFID tag according to claim 1, wherein the sealing material has a dielectric constant of not less than 3.5.

8. The RFID tag according to claim 1, wherein the substrate includes polyimide or glass epoxy, and the sealing material is mainly composed of epoxy, carbon, and silica.

9. The RFID tag according to claim 1, wherein the antenna is formed on only one side of the substrate, and the antenna, the IC chip, and a wire for wire bonding are sealed together using the sealing material to be not exposed in the surface of the sealing material.

10. An automatic recognition system comprising:
an RFID tag according to claim 1, and
any one of a reader and a reader/writer.

11. The RFID tag according to claim 1, wherein
the operation frequency of the IC chip is in a range from 0.86 to 0.96 GHz.

12. The RFID tag according to claim 2, wherein
constituent portions of the antenna adjacent to each other with a gap therebetween provide a capacitance, and the substantial capacitance of the entire structure including the IC chip and the antenna provided in the part around the IC chip is higher than the capacitance of the IC chip alone.

13. The RFID tag according to claim 2, wherein
the IC chip is directly connected to ends of the antenna by wire bonding or flip-chip connection.

14. The RFID tag according to claim 2, wherein
the conductor width/conductor interval of the antenna is in a range from 0.2/0.2 mm to 0.05/0.05 mm.

15. The RFID tag according to claim 2, wherein the sealing material has a dielectric constant of not less than 2.6.

16. The RFID tag according to claim 2, wherein the sealing material has a dielectric constant of not less than 3.5.

17. The RFID tag according to claim 2, wherein the substrate includes polyimide or glass epoxy, and the sealing material is mainly composed of epoxy, carbon, and silica.

18. The RFID tag according to claim 2, wherein the antenna is formed on only one side of the substrate, and the antenna, the IC chip, and a wire for wire bonding are sealed together using the sealing material to be not exposed in the surface of the sealing material.

19. An automatic recognition system comprising:
an RFID tag according to claim 2, and
any one of a reader and a reader/writer.

20. The RFID tag according to claim 2, wherein
the operation frequency of the IC chip is in a range from 0.86 to 0.96 GHz.

21. The RFID tag according to claim 3, wherein
the IC chip is directly connected to ends of the antenna by wire bonding or flip-chip connection.

22. The RFID tag according to claim 3, wherein
the conductor width/conductor interval of the antenna is in a range from 0.2/0.2 mm to 0.05/0.05 mm.
